(19) United States
(12) Patent Application Publication
(10) Pub. No.: US 2015/0157524 A1
(43) Pub. Date: Jun. 11, 2015

(54) Sleeve-Wrap Compression System and Method

(71) Applicants: Lawrence G. Reid, JR., Germanton, NC (US); George T. Hicks, Walnut Cove, NC (US)

(72) Inventors: Lawrence G. Reid, JR., Germanton, NC (US); George T. Hicks, Walnut Cove, NC (US)

(21) Appl. No.: 14/098,730

(22) Filed: Dec. 6, 2013

(51) Int. Cl. A61H 1/00

(52) U.S. Cl. CPC A61H 1/008

(57) ABSTRACT

A sleeve-wrap compression system can include a seamless, inner sleeve comprising a long-stretch elastomeric material and an interior terry surface; and an elongated outer wrap comprising a long-stretch elastomeric material. When applied to a patient's limb, the inner sleeve can exert a first compressive pressure that secures the inner sleeve in a therapeutic position on the limb. When applied by stretching over the inner sleeve, the outer wrap can exert a second compressive pressure and frictionally engage the inner sleeve, thereby securing the compression system as a single compressive entity in the therapeutic position on the limb.

### FIELD OF THE INVENTION

The present invention relates to a sleeve-wrap compression system and method. Embodiments of the sleeve-wrap compression system and/or method may be useful in the treatment and/or management of venous leg ulcers and other wounds.

### BACKGROUND OF THE INVENTION

Compression bandages and garments are used in the treatment of edema and other venous and lymphatic disorders, for example, of the lower limbs. An area where compression bandages and garments are considered particularly useful is in the treatment and management of complications related to venous congestion and chronic wounds, such as venous leg ulcers.

Many venous leg ulcer treatments employ the application of a three or four layer compression bandage. In such conventional multi-layer bandaging, a combination of different types of bandage layers is used in order to provide an accumulation of pressure in layers and to provide rigidity. Such bandages have disadvantages, including difficulty in applying the multiple layers of bandages, and in particular, to obtain a desired pressure and/or a relatively uniform pressure. The application process is time consuming. And, such bandages are prone to slipping and/or forming wrinkles after being applied, which may result in insufficient and/or uneven compression being applied, discomfort to the patient, and/or skin lesions.

Other compression bandage systems have been proposed in attempts to provide bandaging systems that are easier to apply. However, such systems often do not provide or maintain a desired therapeutic compressive pressure for extended periods of time. Furthermore, such systems typically still have a tendency to slip and/or wrinkle after application.

Thus, there is a need for a multi-layer, and in particular, a two-layer, compression therapy system that is easy to apply. There is a need for such a compression therapy system that incorporates the advantages of elastic compression hosiery in a two-layer system. In particular, there is a need for such a compression therapy system that reliably stays in place on a patient's limb, that maintains an initial working compression profile on the limb over time, and that provides a gradual response to a change in limb volume.

### SUMMARY OF THE INVENTION

Some embodiments of a compression system of the present invention can include a seamless, inner sleeve comprising a long-stretch elastomeric material and an interior terry surface; and an elongated outer wrap comprising a long-stretch elastomeric material. When applied to a patient's limb, the inner sleeve can exert a first compressive pressure that secures the inner sleeve in a therapeutic position on the limb. When applied by stretching over the inner sleeve, the outer wrap can exert a second compressive pressure and frictionally engage the inner sleeve, thereby securing the compression system as a single compressive entity in the therapeutic position on the limb.

In some embodiments, the first compressive pressure exerted by the inner sleeve can comprise about 5-10 mm Hg of compressive pressure uniformly throughout the sleeve. In some embodiments, the inner sleeve can further comprise a stitch construction that permits horizontal stretch with minimal vertical stretch. In some embodiments, the inner sleeve can further comprise a reciprocated heel pouch and an open toe, each adapted to guide application of the inner sleeve and to maintain the inner sleeve in the therapeutic position on the limb. In this way, wrinkling and/or bunching of the inner sleeve are reduced so that the inner sleeve compacts evenly onto the limb under the compressive pressure exerted by the outer wrap. The inner sleeve can be configured to disperse the compressive pressure exerted by the outer wrap smoothly about the therapeutic position on the limb.

In some embodiments, the second compressive pressure exerted by the outer wrap can comprise defined amounts of compressive pressure correlated with various amounts of stretch. In some embodiments, the outer wrap can further comprise a range of stretch to about 165% greater than a relaxed length. In some preferred embodiments, the second compressive pressure exerted by the outer wrap from a first stretch to an about 30% greater length than a relaxed length to a second stretch to an about 100% greater length than the relaxed length ranges from about 20 mm Hg to about 30 mm Hg of compressive pressure. For example, in some preferred embodiments, the outer wrap is configured to provide about 5-10 mm Hg compressive pressure when stretched to a first, about 30% greater length than a relaxed length, about 20 mm Hg compressive pressure when stretched to a second, about 75% greater length than the relaxed length, and about 30-35 mm Hg compressive pressure when stretched to a third, about 100% greater length than the relaxed length. In some embodiments, the outer wrap can further comprise a stitch construction that permits longitudinal stretch with minimal cross-stretch.

In some embodiments, the long-stretch elastomeric material in the outer wrap can comprise spandex having a denier of about 380-440. In some embodiments, the outer wrap can further comprise about 12-18 ends of spandex per inch.

In some embodiments, the first compressive pressure exerted by the inner sleeve and the second compressive pressure exerted by the outer wrap cumulatively comprise a working compression profile. In certain embodiments, the compression system further comprises an elastic stress/strain curve such that the single compressive entity provides a gradual change in the working compression profile in response to a change in limb volume. In certain other embodiments, the single compressive entity can maintain an initial working compression profile on the limb within a defined therapeutic range during changes in limb volume. In certain yet other embodiments, the single compressive entity can maintain an initial working compression profile on the limb with a variance of less than about 20% over a seven day period.

Embodiments of the compression system can further comprise a color/compression change indication system. In one embodiment of the color/compression change indication system, a particular amount of stretch of the outer wrap creates a unique shade of color representative of a particular amount of compressive pressure. In this way, a user can readily determine a proper amount of stretch for providing a desired amount of compressive pressure.

In some embodiments, each of the inner sleeve and the outer wrap further comprise broad spectrum anti-microbial properties. In some embodiments, each of the inner sleeve and the outer wrap further comprise a hydrophilic yarn adapted to wick moisture/fluid from a wound and surrounding skin to an outer surface of the outer wrap. For example, the inner sleeve hydrophilic yarn can comprise a knitted terry yarn.

In some embodiments, the compression system can further comprise a plurality of the outer wraps, wherein a second of the outer wraps can be applied on top of the first of the outer wraps in a three-layer system. In some embodiments, the outer wrap can comprise a cohesive wrap.

In some embodiments, the compression system can comprise a seamless sleeve comprising (a) a long-stretch elastomeric material, (b) a stitch construction that permits horizontal stretch with minimal vertical stretch, and (c) an interior terry surface. In such a system, when the sleeve is applied to a patient's limb, the sleeve exerts about 5-10 mm Hg of compressive pressure uniformly throughout the sleeve that secures the sleeve in a therapeutic position on the limb. In such an embodiment, the sleeve can be configured to have secured thereto a compression wrap overlying the sleeve. In some such embodiments, the sleeve can further comprise a reciprocated heel pouch and an open toe, each adapted to guide application of the sleeve and to maintain the sleeve in the therapeutic position on the limb. In such an embodiment, wrinkling and/or bunching of the sleeve are reduced and the sleeve compacts evenly onto the limb under compressive pressure exerted by the overlying compression wrap. The sleeve can also be configured to disperse the compressive pressure exerted by the overlying compression wrap smoothly about the therapeutic position on the limb.

In some embodiments, the compression system can comprise an elongated wrap comprising (a) a long-stretch elastomeric material, (b) a stitch construction having minimal cross-stretch, and (c) a range of longitudinal stretch to about 165% greater than a relaxed length. In such a system, when the wrap is applied to a patient's limb, the wrap exerts a compressive pressure that secures the wrap in a therapeutic position on the limb. In such a system, the compressive pressure exerted by the wrap can comprise defined amounts of compressive pressure correlated with various amounts of longitudinal stretch. In such a system, the compressive pressure exerted by the wrap from a first stretch to an about 30% greater length than the relaxed length to a second stretch to an about 100% greater length than the relaxed length can range from about 20 mm Hg to about 30 mm Hg of compressive pressure. For example, the wrap can be configured to provide about 5-10 mm Hg compressive pressure when stretched to a first, about 30% greater length than the relaxed length, about 20 mm Hg compressive pressure when stretched to a second, about 75% greater length than the relaxed length, and about 30-35 mm Hg compressive pressure when stretched to a third, about 100% greater length than the relaxed length. In some embodiments of such a system, the long-stretch elastomeric material in the wrap can comprise spandex having a denier of about 380-440, and the wrap can further comprise about 12-18 ends of spandex per inch.

Features of a sleeve-wrap compression system and/or method of the present invention may be accomplished singularly, or in combination, in one or more of the embodiments of the present invention. As will be realized by those of skill in the art, many different embodiments of a fabric, garment, and/or method according to the present invention are possible. Additional uses, advantages, and features of the invention are set forth in the illustrative embodiments discussed in the detailed description herein and will become more apparent to those skilled in the art upon examination of the following.

### BRIEF DESCRIPTION OF THE DRAWINGS

FIG. 1 is a plan view of the sleeve of the sleeve-wrap compression system in position on a patient's lower leg in an embodiment of the present invention.

FIG. 2 is a perspective view of the wrap of the sleeve-wrap compression system in rolled form ready to be applied to a patient's limb in an embodiment of the present invention.

FIG. 3 is a plan view of the wrap overlapped onto itself after being applied over the sleeve (not shown) on a patient's lower leg in an embodiment of the present invention.

FIG. 4 is a graphic view of the first shade of brown representing the first length (or light) stretch, the second shade of brown representing the second length (or medium) stretch, and the third shade of brown representing the third length (or firm) stretch in the color/compression change indication system in an embodiment of the present invention.

FIG. 5 is a plan view of the wrap positioned on a foot and lower leg, with sufficient tension so that the wrap consistently exhibits the third shade of brown in an embodiment of the present invention.

FIG. 6 is a graphic view of a high slope value, or steep stress/strain curve, of a stiff compression garment.

FIG. 7 is a graphic view of a stress strain curve of a moderately stiff compression device.

FIG. 8 is a graphic view of the more gradual slope value, or stress/strain curve, of the sleeve-wrap compression system of the present invention.

FIG. 9 is a graphic view of data points showing that the sleeve-wrap system maintains working compression within a desired range for seven days while the system is being worn.

FIG. 10 is a graphic view illustrating anti-microbial action by the copper in the wrap and by the silver in the sleeve, the presence of hydrophilic wicking fibers in the sleeve and in the wrap, and vertical wicking of moisture/exudate through the sleeve layer and through the wrap layer to the surface of the wrap layer.

### DETAILED DESCRIPTION

For the purposes of this description, unless otherwise indicated, all numbers expressing quantities, conditions, and so forth used in the description are to be understood as being modified in all instances by the term “about.” Accordingly, unless indicated to the contrary, the numerical parameters set forth in the following description are approximations that can vary depending upon the desired properties sought to be obtained by the embodiments described herein. At the very least, and not as an attempt to limit the application of the doctrine of equivalents to the scope of the invention, each numerical parameter should at least be construed in light of the number of reported significant digits and by applying ordinary rounding techniques.

Notwithstanding that the numerical ranges and parameters setting forth the broad scope of the described embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, for example, 5.5 to 10.

As used in this description, the singular forms “a,” “an,” and “the” include plural referents unless the context clearly dictates otherwise. Thus, for example, the term “a wrap” is intended to mean a single wrap or more than one wrap. For the purposes of this specification, terms such as “proximal,” “distal,” “front,” “back,” “right,” “left,” “upwardly,” “downwardly,” and the like are words of convenience and are not to be construed as limiting terms. Additionally, any reference referred to as being “incorporated herein” is to be understood as being incorporated in its entirety.

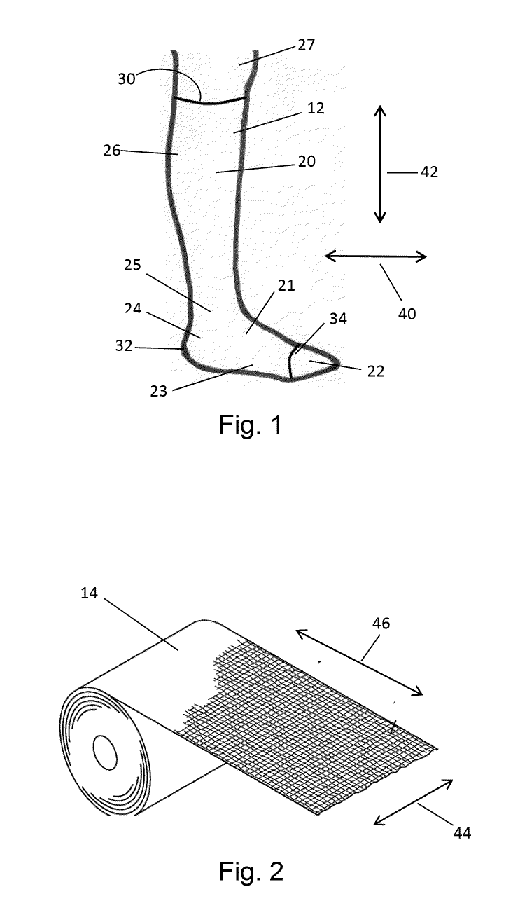

The present invention includes embodiments of a sleeve-wrap compression system and/or method. FIGS. 1-10 illustrate such embodiments. Embodiments of the sleeve-wrap compression system 10 and/or method can comprise multiple compressive pressure layers. The first layer for applying adjacent a patient's skin is a compressive pressure sleeve 12. The second layer that is applied to the top of the first, sleeve layer comprises a compressive pressure wrap 14. Embodiments of the sleeve-wrap compression system 10 can include one or more compressive pressure wrap layers 14 on top of the sleeve 12. Preferred embodiments of the multi-layer sleeve-wrap compression system 10 comprise a two-layer system comprising a sleeve layer 12 and a single wrap layer 14. The system 10 is useful for the treatment and management of venous leg ulcers and/or other complications of venous incompetency. Certain embodiments of the sleeve-wrap compression system 10 can be utilized for treatment of lymphedema and/or other edematous conditions of body extremities.

It has been found that the combination of the inner sleeve layer 12 and the outer wrap layer 14 according to embodiments of the sleeve-wrap compression system 10 provide particular desirable and advantageous features for effective wound treatment. For example, the sleeve and wrap layers 12, 14, respectively, are easy to properly apply by professional and lay caregivers. Once applied, the sleeve-wrap compression system 10 can be reliably maintained in a desired position on a patient's limb 20 with minimal slippage. It was found that the sleeve-wrap compression system 10 provides consistent compressive pressure during an extended wear period, for example, over 5-7 days. In contrast to stiffer compression systems, the sleeve-wrap system 10 provides a controlled, gradual change in applied compressive pressure in response to a change in limb volume. Quite advantageously for effective wound treatment, the sleep-wrap compression system 10 provides consistent compressive pressure during varying degrees of patient activity and rest. Thus, the sleeve-wrap compression system 10 is able to control applied compressive pressure so as to maintain a consistent working compression profile. As a result, the sleeve-wrap compression system 10 can maintain an optimal, therapeutic level of compressive pressure for the treatment of leg ulcers over time.

The sleeve layer 12 of the sleeve-wrap compression system 10 comprises a tubular sleeve similar to a compression stocking or hosiery. FIG. 1 shows the sleeve 12 in place on a patient's lower leg 20. The sleeve 12 is designed to be slid over a patient's limb 20, such as over a foot 21, toe 22, instep 23, heel 24, ankle 25, and calf 26, or over a hand and arm. Various embodiments of the sleeve 12 can be configured to cover different lengths of a limb 20. Typically, a lower limb sleeve 12 can extend from the foot 21 to just below the wearer's knee 27. The sleeve layer 12 can be fabricated with a variety of materials suitable for application on the skin and for providing compressive pressure. In preferred embodiments, the sleeve layer 12 comprises spandex in combination with nylon, acrylic, polyester, and/or cotton.

One aspect of the present invention is that the sleeve layer 12 provides a smooth dispersal of compression over the limb 20 to which it is applied. The sleeve layer 12 of the sleeve-wrap compression system 10 can be made in a seamless manner. In some preferred embodiments, the sleeve 12 is constructed to include a knitted terry lining 30 on the entire inner, skin facing surface of the sleeve 12. A knitted terry fabric 30 is a plated fabric knitted with two different yarns. A ground yarn appears on one side of the fabric, and a looped, or effect, yarn is pulled out the other, technical side of the fabric to make a looped or pile texture. The seamless, terry lined sleeve 12 provides a smooth surface next to the skin in which there is no overlapping of fabric. The beneficial effect is that there are no hard compression lines or creases on the skin due to fabric overlapping or from edges of the sleeve 12 on the limb 20. As a result, the sleeve 12 provides a smooth dispersal of compression over the limb 20 from the overlying wrap 14. This smooth application of compression helps protect already compromised skin, prevent further skin breakdown in areas adjacent the wound, and enhance compressive pressure therapy. Thus, the sleeve layer 12 of the sleeve-wrap compression system 10 provides an advantage over conventional multi-layer compression systems in which overlapping of fabric in the wrap adjacent a patient's skin causes creases in the skin, thereby promoting skin breakdown. In addition, the interior terry lining 30 in the sleeve layer 12 provides a soft cushioning that enhances comfort of the wearer.

The yarn comprising the terry lining 30 can comprise a thermally adaptive yarn, such as a yarn incorporating Outlast® technology, that goes through phase changes to control temperature (available commercially from Outlast Technologies LLC, 831 Pine Ridge Road, Golden Colo. 80403). Such technology utilizes phase change materials that absorb, store, and release heat for enhanced thermal comfort. As the skin gets hot, the heat is absorbed by microencapsulated phase change materials, and as it cools, that heat is released. In this way, heat is managed proactively and the production of moisture is controlled before it begins. Accordingly, fabric that incorporates this type of yarn results in decreased sweating by the wearer. Thus, such temperature responsive fabric in the sleeve 12 provides the advantages of enhancing patient comfort and, by helping to keep the wound dry in warm conditions and decreasing vasoconstriction in cooler conditions, enhances wound healing as well.

Another aspect of the present invention is that the sleeve layer 12 stays in place on a patient's limb 20. Maintaining a compression system in proper position on a patient's limb is critical to provide accurate compressive pressures to the limb/wound. One of the biggest disadvantages of compression systems that utilize only wraps is that the wraps do not reliably stay in place.

In embodiments of the sleeve 12 having an interior terry lining 30, the soft, textured quality of the terry lining 30 provides a particularly desirable and effective gripping onto the skin of a patient, which minimizes any tendency of the sleeve towards slippage after application. That is, the terry lining 30 of the sleeve 12 helps keep the sleeve 12 in a desired position about a patient's limb 20.

In some embodiments, the sleeve 12 can be constructed to have the anatomical contour of a limb 20. Such shaped construction of the sleeve 12 can be accomplished by manipulating the knitting program so as to control tension of the spandex and elongation of the stitch to produce a contoured shape. An anatomically contoured sleeve 12 provides a more snug fit onto the limb 20. As a result, wrinkling and/or bunching of sleeve fabric, for example, on the top of the foot 21, is significantly reduced or eliminated. This decreases the risk that skin irritation or adverse pinpoint pressure on the wound would occur as a result of fabric creases in the sleeve 12. In this way, the sleeve 12 protects bony prominences. In addition, without extra fabric in the folds and crevices of a limb, an anatomically contoured sleeve allows the sleeve 12 to compact evenly onto the limb 20 under pressure from the overlying wrap 14. Thus, under compressive pressure from the wrap 14, the sleeve 12 remains both smooth and in place.

In particular, in some embodiments, the sleeve 12 can include a reciprocated heel pocket or pouch 32. A reciprocated heel 32 is formed by the three-dimensional shaping of a pouch, achieved on a small-diameter hosiery knitting machine by using held loop shaping so that the number of courses knitted by adjacent needles is varied in order to knit a pouch for the heel. During pouch knitting, the rotating movement of the cylinder changes to a semi-circular or oscillatory (reciprocated) movement using selected needles to produce the heel pouch 32. The reciprocated heel pouch 32 allows the sleeve to have a more formed fit about the heel 24 of a wearer. As a result, the reciprocated heel 32 in the sleeve 12 helps ensure proper positioning of the sleeve 12 about the limb 20, thereby helping to reduce wrinkling and/or bunching of fabric on the top of the foot 21 and elsewhere.

In some embodiments, the sleeve 12 can be constructed to include an open toe 34. The open toe 34 provides further ability to apply the sleeve 12 in a desired position about the foot 21 and lower limb 20. Moreover, the open toe 34 ensures that the patient's toes 22 are not being compressed, and allows easy access to assess vascular supply and condition of the forefoot.

In some embodiments, the sleeve 12 and the wrap 14 can each be constructed so that the interior of the wrap 14 and the exterior of the sleeve 12 exert a desirably enhanced amount of friction between them when the wrap 14 is applied to the sleeve 12. An enhanced friction co-efficient between the sleeve 12 and the wrap 14 helps to maintain the wrap 14 in position on the sleeve 12, thereby decreasing the potential for downward slippage and helping to maintain the entire sleeve-wrap system 10 in proper position on the limb 20. As a result, the risk of skin irritation from displaced compression layers is reduced and the delivery of consistent compressive pressure for optimal wound healing is enhanced.

In some embodiments, the sleeve 12 comprises a construction that permits horizontal stretch 40 with minimal vertical, or longitudinal, stretch 42. Horizontal stretch 40 creates tension around the circumference of the limb 20, which helps keep the sleeve 12 up on the limb 20 and thus avoid undesirable slippage. An ability to stretch to a large degree vertically 40 (along the longitudinal axis of a limb) creates the potential for a garment to slip downward. To provide minimal vertical stretch, the sleeve 12 can be constructed so as to pack stitches in the vertical direction, which causes the knitted fabric to resist stretching in the vertical direction 40. In some embodiments, such a construction comprises spandex yarns “laid in” horizontally into the knit structure without formation of stitches or loops to hold the spandex. In a “laid in” fabric, a base structure of knitted or overlapped threads hold in position other non-knitted threads which are incorporated, or “laid in,” into the structure during the same knitting cycle. Although an inlaid yarn is not formed into a knitted loop, the base fabric structure can utilize various knitting stitches to hold the inlaid yarn in place. Laying in spandex yarns horizontally in the sleeve allows horizontal stretch 40, while avoiding an additional course of interlocking loops that permit stretch in the vertical direction 42. Thus, as compared to an approximately 100% vertical stretch 42 resulting from knitted spandex yarns, horizontally laid-in spandex yarns can reduce vertical stretch 42 in the sleeve 12 to about 30%.

The sleeve 12 of the sleeve-wrap compression system 10 can be constructed so that the horizontal stretch 40 provides a small, uniform amount of compressive pressure throughout the length of the sleeve 12. For example, in preferred embodiments, the sleeve 12 can provide about 5-10 mm Hg of compressive pressure along the length of the sleeve 12. A small amount of compressive pressure allows the sleeve 12 to be sufficiently elastic so as to grip the contours of the limb 20 to which it is applied and help maintain the sleeve 12 in its original position over time. In contrast, each of the layers in conventional multi-layer compression systems comprises a wrap. Over time, the multiple wraps tend to move up and/or down along a patient's limb and thus become more loosely (or more tightly) wrapped about the limb. As a result, such conventional multi-layer wrap systems can lead to undesirably varying amounts of compressive pressure on the limb. However, a small, uniform amount of compressive pressure in embodiments of the sleeve 12 of the sleeve-wrap compression system 10 helps keep the sleeve 12 in a desired position.

Similarly, a small amount of compressive pressure allows the sleeve 12 to be sufficiently elastic with respect to changes in limb circumference due to edema that the sleeve 12 can provide a consistent, uniform compressive pressure in response to such change. That is, with reference to the description related to FIGS. 6-8, the sleeve 12 can be constructed so that its elasticity exhibits a relatively flat stress/strain curve. As the sleeve is stretched/stressed, even to a large degree, by increasing limb circumference, the amount of compressive pressure (strain) applied to a patient's limb 20 remains within a controlled, narrow range. In this way, the sleeve 12 overcomes the problem of varying pressures in conventional multi-layer wrap systems by providing a consistent, uniform amount of compressive pressure along the length of the sleeve 12 over time.

In addition, the amount of compressive pressure provided by the underlying sleeve 12 serves to limit the amount of pressure that the overlying wrap 14 must provide to reach a particular cumulative pressure. Thus, a single wrap 14 can be constructed to exert a lesser amount of pressure, which makes the wrap 14 easier to apply.

Each of these aspects of the sleeve-wrap compression system 10 individually, and particularly in combination, helps keep the sleeve 12 in a desired position on a limb 20 so that a stable compressive pressure can be maintained by the sleeve 12 and the overlying wrap 14. In addition, such features in the sleeve 12 provide a smooth dispersal of compression from the overlying wrap 14, thereby further enhancing control of compressive pressure onto the limb 20 so as to optimize treatment of venous ulcers.

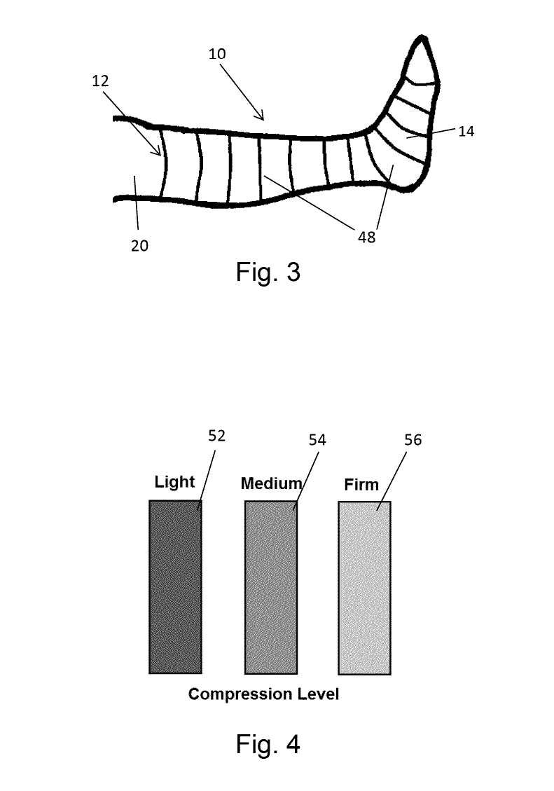

Embodiments of the wrap layer 14 of the sleeve-wrap compression system 10 can comprise an elongated elastic wrap, or bandage. FIG. 2 shows the wrap 14 in rolled form ready to be applied to a patient's limb 20. The wrap 14 preferably includes spandex in combination with nylon and/or cotton. In some preferred embodiments, the wrap 14 comprises a width 44 of about four inches. It was discovered that the wrap 14 that is four inches wide stays in place on the underlying sleeve 12 without slippage better than a three-inch wrap, particularly in the heel region 24. Preferably, the wrap 14 comprises a sufficient length so that when the wrap is applied with a 50% overlap 48 onto itself the wrap 14 covers the length of the underlying sleeve 12 on a patient's limb 20. FIG. 3 shows the wrap 14 overlapped 48 onto itself after being applied over the sleeve 12 (not shown) on a patient's lower leg 20.

In some embodiments, the wrap 14 can comprise a material in which at least the exterior surface has one portion of a hook-and-loop type fastener that is engagable with a mating portion of such a fastener. In this way, after the wrap 14 is applied, it can be secured to itself with one or more strips of a mating portion of the hook-and-loop type fastener. The hoop-and-loop fastening capability is advantageous for securing the wrap 14, as opposed to metal clips that can be uncomfortably bulky or tape that is susceptible to slippage from moisture. When the hook-and-loop fastening enabled wrap 14 is being applied onto a patient's limb, one overlapping portion of the wrap 14 is adhered to another underlapping portion 14. In this way, the wrap 14 can be secured onto itself about the anatomical contours of the limb 20, such as about a patient's heel 24. Such contoured securing of the wrap 14 helps maintain the wrap 14, and the sleeve-wrap compression entity 10, in a desired therapeutic position on the limb 20. In certain embodiments, pieces of a mating portion of a hook-and-loop type fastener can be adhered to one or more areas on the hook-and-loop fastening enabled wrap 14 to create a smooth surface on the wrap 14. For example, pieces of a mating portion of a hook-and-loop type fastener can be adhered to the wrap 14 at the back of the heel 24 and/or on top of the foot 21 to create smooth, anti-friction areas.

Various wraps 14 can be constructed to provide different amounts of compressive pressure. The amount of compressive pressure a particular wrap 14 will provide depends on stretch characteristics selected during construction of the wrap 14 and the amount of stretch applied to the wrap 14 while it is being overlaid onto the sleeve 12. The amount of compressive pressure therapy desired depends on the clinical use of the wrap 14 and the individual patient. For example, the wrap layer 14 of the sleeve-wrap compression system 10 designed for treatment of a leg ulcer may provide compressive pressure at the instep ankle area 23/25 in the range of about 10-60 mm Hg, preferably in the range of about 20-45 mm Hg, and may provide compressive pressure at the calf area 26 in the range of about 10-60 mm Hg, preferably in the range of about 15-40 mm Hg. One embodiment of the outer wrap layer 14 that is particularly useful in the treatment of venous leg ulcers is configured to provide between about 5-10 mm Hg compressive pressure and about 30-35 mm Hg compressive pressure depending on the amount of longitudinal stretch 46 applied to the wrap 14.

The sleeve layer 12 can provide a uniform, low level compression, for example, about 5 mm Hg of compressive pressure. Therefore, such preferred embodiments of the sleeve-wrap compression system 10 can provide cumulative compressive pressures at the instep/ankle area 23/25 in the range of about 25-50 mm Hg, and at the calf area 26 in the range of about 20-45 mm Hg. The cumulative applied compressive pressure in the sleeve-wrap compression system 10 may be a uniform amount throughout the length of the system 10, or may be graduated from a larger pressure at the instep/ankle area 23/25 to a smaller pressure at the calf area 26. In an embodiment of the sleeve-wrap compression system 10 intended for use with lymphedema, the cumulative applied compressive pressure can be as high as 100 mm Hg at the ankle 25.

One of the benefits of utilizing the sleeve-wrap compression system 10 in wound care is that the compressive pressure helps decrease edema. In some embodiments of the sleeve-wrap compression system 10, the wrap portion 14 comprises stretch characteristics that help control changes in applied compressive pressure as edema is reduced and the volume of a limb 20 changes. The stretch characteristics in such a wrap 14 having defined stretch—compressive pressure relationships are provided by a balance of several factors, including (1) size or denier of spandex; (2) stretch characteristics of spandex; and (3) the number of ends per unit of measure, or density, of spandex in the wrap fabric. For example, in some embodiments, the denier of spandex can vary from about 20 denier to about 600 denier, preferably from about 350 denier to about 500 denier. In some embodiments, the spandex-comprising wrap 14 can stretch 46 to about 400% greater than its relaxed length, preferably to about 200% greater than its relaxed length. In some embodiments, the wrap 14 can comprise from about 5 ends to about 50 ends of spandex per inch, preferably from about 5 ends to about 20 ends per inch.

In some preferred embodiments, the wrap 14 has a maximum stretch 46 of about 165% greater than its relaxed length and a clinically usable stretch 46 of about 30% to about 100% greater than its relaxed length. In particularly preferred embodiments, when the wrap 14 is stretched to a first, about 30% greater length, the compressive pressure applied to an exemplary nine-inch circumference is about 5-10 mm Hg. When the wrap 14 is stretched to a second, about 75% greater length, the compressive pressure applied to an exemplary nine-inch circumference is about 20 mm Hg. And when the wrap 14 is stretched to a third, about 100% greater length, the compressive pressure applied to an exemplary nine-inch circumference is about 30-35 mm Hg. That is, the compressive pressure applied by the wrap 14 in such preferred embodiments can range about 20-30 mm Hg pressure from a light stretch (the first, about 30% stretch) of the wrap 14 to a firm stretch (the third, about 100% stretch) of the wrap 14.

These references to stretch of the wrap 14 refer to lengthwise extension of the wrap 14, or “vertical” (longitudinal) stretch 46. In some embodiments, the wrap 14 can be constructed to have vertical, or longitudinal, stretch 46 (that is, in the warp direction) with minimal horizontal stretch, or cross-stretch 44 across the width of the wrap 14 (that is, in the weft direction). Minimization of cross-stretch 44 in the wrap 14 helps conform the wrap 14 to the curvature of a patient's limb 20, thereby reducing the possibility of the wrap 14 producing any fabric folds around anatomical structures of the limb 20.

Such predetermined stretch characteristics in embodiments of the sleeve-wrap compression system 10 allow the wrap 14 to be stretched a particular amount to provide compressive pressure levels within a prescribed range. Applying and maintaining accurate compressive pressure helps ensure that a desired level of therapy for a wound is achieved.

Embodiments of the compression system 10 of the present invention can further comprise a color/compression change indication system 50 in which a particular amount of stretch of the wrap 14 creates a unique color, or shade of color, representative of a particular amount of compressive pressure. To accomplish a change in color, or shade, the wrap is fabricated with an intended “grin,” or “grin-through,” capability. Grin/grin-through is defined as the appearance of an interior layer of material when a fabric is stretched. For example, a core yarn having one color can be covered with a covering yarn having a different color. When a fabric comprising the differently colored core and cover yarns is stretched, the turns of the cover yarn can separate so that the core yarn is exposed through the cover yarn. The amount of separation of the cover yarn is directly related to the degree to which the fabric/yarn is stretched. Thus, the more a fabric is stretched, the more the turns of the cover yarn separate, resulting in a greater amount of grin-through of the core yarn color. Likewise, the more a fabric is stretched, the greater the change in color or shade of the fabric.

Applicant's co-pending U.S. patent application Ser. No. 13/709,080, entitled “Color Change Compression Fabrics and Garments,” further describes such a color change capability. This application is incorporated by reference herein in its entirety. As applied to the sleeve-wrap compression system 10, some embodiments of the wrap 14 can comprise an elastic material having one color, or shade, in an unstretched condition that changes to a different color, or shade, in a stretched condition. The different, stretched color corresponds to a predetermined amount of stretch applied to the material, which in turn corresponds to a predetermined amount of compressive pressure. The stretched color can comprise a first stretched color corresponding to a first predetermined amount of stretch and a second stretched color corresponding to a second predetermined amount of stretch. The first amount of stretch and the second amount of stretch can each correspond to a different predetermined amount of compressive pressure.

For example, the wrap 14 can comprise a covering yarn comprising a covering yarn color and wrapped a number of turns about an elastic yarn comprising an elastic yarn color different than the covering yarn color. When the wrap 14 is stretched a first amount, the turns of the covering yarn move apart from each other to expose a first amount of the elastic yarn color corresponding to a first predetermined amount of compressive pressure. Likewise, when the wrap 14 is stretched a second amount, the turns of the covering yarn move apart from each other to expose a second amount of the elastic yarn color corresponding to a second predetermined amount of compressive pressure. That is, each of different amounts of wrap stretch can provide a unique color profile of a different combination of the covering yarn color and the elastic yarn color. Each unique color profile can correspond to a different amount of compressive pressure.

In one embodiment of the sleeve-wrap compression system 10, the wrap 14 comprises yarns have a core yarn that is white and a covering yarn that is brown. In a relaxed, unstretched state, the wrap 14 exhibits the brown color of the cover yarn. When the wrap 14 is stretched to a first length that is about 30% greater than its relaxed length, a first amount of the white color of the core yarn grins through the cover yarn to exhibit a first shade of brown 52 that is lighter than the “undiluted” brown of the cover yarn. When the wrap 14 is further stretched to a second length that is about 75% greater than its relaxed length, a second, greater amount of the white color of the core yarn grins through the cover yarn to exhibit a second shade of brown 54 that is even lighter than the first shade of brown 52. When the wrap 14 is further stretched to a third length that is about 100% greater than its relaxed length, a third, still greater amount of the white color of the core yarn grins through the cover yarn to exhibit a third shade of brown 56 that is even lighter than the second shade of brown 54. FIG. 4 shows the first shade of brown 52 representing the first length (or light) stretch, the second shade of brown 54 representing the second length (or medium) stretch, and the third shade of brown 56 representing the third length (or firm) stretch.

The shade of color produced by a certain amount of fabric stretching in the wrap 14 is associated with a particular level of compressive pressure. For example, in some preferred embodiments, when the wrap 14 is stretched to the first, about 30% greater length, the compressive pressure applied to an exemplary nine-inch circumference is about 5-10 mm Hg. When the wrap 14 is stretched to the second, about 75% greater length, the compressive pressure applied to an exemplary nine-inch circumference is about 20 mm Hg. And when the wrap 14 is stretched to the third, about 100% greater length, the compressive pressure applied to an exemplary nine-inch circumference is about 30-35 mm Hg. Accordingly, when the wrap 14 is applied to an exemplary nine-inch circumference with the first, about 30% stretch, the first shade of brown 52 exhibited by the wrap 14 represents a compressive pressure of about 5-10 mm Hg. With the second, about 75% stretch, the second shade of brown 54 exhibited by the wrap represents a compressive pressure of about 20 mm Hg. And with the third, about 100% stretch, the third shade of brown 56 exhibited by the wrap 14 represents a compressive pressure of about 30-35 mm Hg. That is, the compressive pressure applied by the wrap 14 in such preferred embodiments can range about 20-30 mm Hg pressure from a light stretch (the first, about 30% stretch) of the wrap 14 to a firm stretch (the third, about 100% stretch) of the wrap 14.

In an alternative embodiment, the sleeve-wrap compression system 10 can include a color/compression change indication system 50 in which a particular amount of stretch of the wrap 14 reveals a unique indicator, such as a particular shape or design, representative of a particular amount of compressive pressure. The indicator can comprise one or more indicia knitted into, or printed onto, the wrap 14. For example, the wrap 14 can include a first indicium comprising a rectangle having a first length that represents a first amount of stretch and a corresponding first predetermined amount of compressive pressure. Stretching the wrap 14 a second, greater amount of stretch causes the appearance of a second indicium comprising a rectangle having a second length that is shorter than the first length. The second indicium uniquely represents the second amount of stretch and a corresponding second predetermined amount of compressive pressure that is greater than the first amount of compressive pressure. Stretching the wrap 14 a third, even greater amount of stretch causes the appearance of a third indicium comprising a rectangle having a third length that is shorter than the second length. The third indicium uniquely represents the third amount of stretch and a corresponding third predetermined amount of compressive pressure that is greater than the second amount of compressive pressure. In such an embodiment, each of different amounts of wrap stretch can provide a unique indicium that represents a different amount of stretch and a corresponding different amount of compressive pressure. In this way, a user of the sleeve-wrap compression system 10 can readily determine a proper amount of stretch in the wrap 14 for providing a desired amount of compressive pressure.

The amount of compressive pressure applied by a compression garment to a limb depends in part on the circumference, or radius, of the limb. It has been proposed that pressure provided by compression hosiery on a limb can be characterized by Laplace's Law for cylindrically-shaped objects, expressed as P=T/r, where P is the internal pressure of the limb, T represents the wall tension across a slice of a cylindrical portion of hosiery, and r is the radius of the limb (the limb is approximated as a cylinder). Laplace's Law implies that the pressure supplied by compression hosiery varies inversely with the radius of the limb. In other words, if tension is equal throughout the garment, less pressure will be provided at a larger radius portion of the limb, such as the calf, than at a smaller radius portion of the limb, such as the ankle.

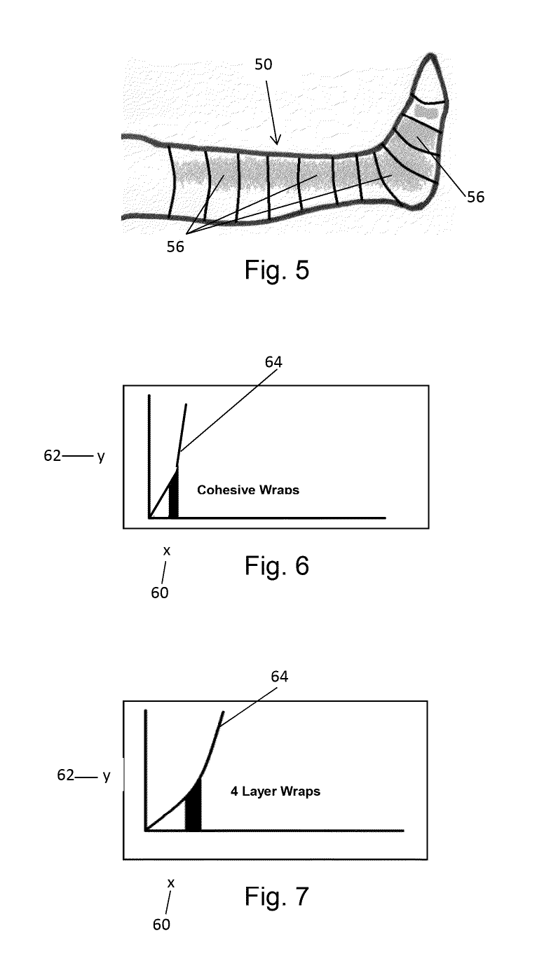

With respect to this inverse relationship between compressive pressure and limb radius, embodiments of the sleeve-wrap compression system 10 can be applied so as to provide desirably graduated compressive pressure from a distal point to a proximal point up a limb 20. As described herein, the sleeve 12 can be fabricated to provide the same small amount of compressive pressure, for example, 5 mm Hg pressure, along its length. By applying the wrap 14 under the same tension, that is, with the same amount of stretch, over the entire length of the sleeve 12, more compressive pressure will be provided at the smaller distal portions of the limb 20 and less compressive pressure will be provided at the larger proximal portions of the limb 20. In this way, the compressive pressure along the limb 20 will be graduated as desired. The relatively same tension, or amount of stretch, along the length 46 of the wrap 14 can be readily accomplished by applying the wrap 14 so that the same shade of color is exhibited throughout the wrap 14. As shown in the example in FIG. 5, in one embodiment, the sleeve 12 is positioned on a foot 21 and lower leg 20. Then a four-inch wide wrap 14 is applied over the sleeve 12 so that the wrap 14 has a 50% overlap onto itself, with sufficient tension so that the wrap 14 consistently exhibits the third shade of brown 56. As a result, the wrap 14 is stretched to the third, about 150% stretch that provides a uniform compressive pressure of about 30-35 mm Hg. The compressive pressure at the distal area of the foot 21 (from the sleeve 12 and wrap 14 together) is thus about 30-35 mm Hg. Since the leg 26 has a larger circumference than the foot 21 and increases in circumference from the ankle 25 to the knee 27, the compressive pressure graduates in a decreasing fashion proximally along the leg 20 such that the compressive pressure at the knee 27 is less than at any other area in the foot 21 or leg 20. Thus, maintaining the same color of the wrap 14 along the leg 20 allows the user to control the amount of compressive pressure being applied. Accordingly, the sleeve-wrap compression system and/or method 10 help ensure a proper desired graduated pressure along the limb 20.

In addition, maintaining the same color or shade of the wrap 14 along the limb 20 to provide a uniform amount of applied compressive pressure allows changes in compression levels along the limb 20 to be smooth even as a reduction in edema causes a decrease in limb girth. That is, maintaining the same applied compressive pressure along the limb 20 ensures that as edema and limb girth are reduced, the compressive pressure along the limb 20 remains graduated as desired. An accurate amount of compressive pressure and properly graduated pressure helps ensure a desired level of therapy.

Similarly, the sleeve-wrap compression system 10 can advantageously provide the same change in compressive pressure across various degrees of stretching on limbs having different sizes. For example, the same compression garment would apply a different amount of compressive pressure to a limb having a 12-inch circumference than to a limb having a 7-inch circumference. However, in embodiments of the sleeve-wrap compression system 10, the stretch-compression characteristics of both the sleeve 12 and the wrap 14 are known and controlled. As a result, the change in compressive pressure from a light stretch (the first, about 30% stretch) of the wrap 14 to a firm stretch (the third, about 100% stretch) of the wrap 14 ranges about 20-30 mm Hg pressure (as illustrated by the example of some preferred embodiments) on any limb circumference to which the sleeve-wrap compression system 10 is applied. In other words, although the compressive pressure provided by a light stretch (the first, about 30% stretch) of the wrap 14 is different on a larger or smaller circumference limb, the change in compressive pressure provided by a firm stretch (the third, about 100% stretch) of the wrap can be about 20-30 mm Hg pressure greater in both the larger and smaller limbs.

The sleeve-wrap compression system 10 achieves a superior “working” compression profile compared to conventional compression systems. That is, the sleeve-wrap compression system 10 provides a consistent amount of compressive pressure over the course of clinical treatment of a wound. The individual features in the sleeve 12 and in the wrap 14, and the synergistic combination of those features, create a single compressive entity 10 that provides a controllable compression profile, particularly in response to a change in limb volume.

For example, as described herein, embodiments of the sleeve component 12 of the sleeve-wrap compression system 10 can include (1) an interior terry lining 30; (2) a reciprocated heel 32; (3) an open toe 34; (4) a contoured design; (5) stitch construction that permits horizontal stretch 40 with minimal vertical stretch 42; and (6) a low level of compressive pressure throughout the sleeve 12. Each of these aspects helps keep the sleeve 12 in a desired position on a limb 20 so that a stable compressive pressure can be maintained by the sleeve 12 and the overlying wrap 14. In addition, such features in the sleeve 12 provide a smooth dispersal of compression from the overlying wrap 14, thereby further enhancing control of compressive pressure onto the limb 20.

Embodiments of the wrap component 14 of the sleeve-wrap compression system 10 can include (1) defined amounts of compressive pressure correlated with various amounts of stretch; (2) a color change indicator system 50 that allows a user to readily determine a proper amount of stretch for controlling the amount of applied compressive pressure; and (3) stretch characteristics that provide long-stretch elastic compression similar to that in compression hosiery. Each of these aspects helps the sleeve-wrap compression system 10 maintain a stable, or consistent, interface pressure with a limb/wound over an extended wear/treatment period. In addition, friction co-efficiencies between the sleeve 12 and the wrap 14 help maintain the compression system 10 as a single compressive entity in proper position on a limb 20, which enhances control of compressive pressure on the limb 20.

The stretch characteristics of the wrap 14 allow the wrap 14 to provide a more elastic response to a change in limb volume, or girth, than responses by a stiffer system, such as a conventional cohesive wrap or four-layer wrap. Stiffness of a compression bandage, wrap, stocking, or other compression garment is measured in terms of slope value on an x/y (horizontal/vertical) axis. For purposes of illustration, stiffness slope value is the change in pressure produced by a 1 cm change in circumference of a limb 20. Change in limb circumference due to increase or decrease in limb volume affects the effective stretch of a compression garment. As increasing edema causes limb circumference to increase, stretch on the compression garment increases, and as decreasing edema causes limb circumference to decrease, stretch on the compression garment decreases. Stretch can be considered “stress” 60 on the garment, and is indicated on the x-axis in FIGS. 6-8. Thus, as stretch/stress 60 of a compression garment increases, the compressive pressure, or “strain” 62, applied by the garment increases. Likewise, as stretch/stress 60 of a compression garment decreases, the compressive pressure, or “strain” 62, applied by the garment decreases. Amount of compressive pressure/strain 62 is indicated on the y-axis in FIGS. 6-8.

As shown in FIG. 6, when a compression garment is stiff, it has a high slope value, that is, a steep stress/strain curve 64. In a stiff compression garment, a small increase in stretch/stress 60 (due to increase in limb circumference) results in a defined increase in actual compressive pressure 62. For example, in a stiff compression garment, a 1 cm increase in limb circumference may produce an increase in compressive pressure/strain 62 of 10 mm Hg. A conventional cohesive wrap, for example, exhibits such a high slope value, or stress/strain curve 64. FIG. 7 illustrates a stress/strain curve 64 for a moderately stiff compression device, that is, less stiff than a cohesive wrap yet not as elastic as a compression hosiery garment. In a moderately stiff compression device, a moderate increase in stretch/stress 60 (due to increase in limb circumference) results in the defined increase in actual compressive pressure 62. For example, in a moderately stiff compression device, an increase in compressive pressure/strain 62 of 10 mm Hg may be produced by a 2 cm increase in limb circumference. That is, in a moderately stiff compression garment, the same amount of increase in compressive pressure 62 as in a stiff compression garment is produced by a larger increase in limb circumference (a larger amount of stretch/strain 60). A conventional four-layer wrap, for example, exhibits such a moderate slope value, or stress/strain curve 64.

The comparative relationships between stretch/stress 60 and compressive pressure/strain 62 in FIGS. 6-7 illustrate that stiffness directly affects the ability to control a change in compressive pressure 62 in response to a change in circumference of a limb. Both stiff and moderately stiff compression garments have sufficiently high stress/strain curves 64 such that a small increase in edema/limb circumference can cause a relatively large increase in compressive pressure 62. The amount of applied compressive pressure 62 must be carefully controlled to ensure effective treatment of venous ulcers, as well as to prevent damage to tissue and/or arterial reflux from too large a pressure, particularly over time.

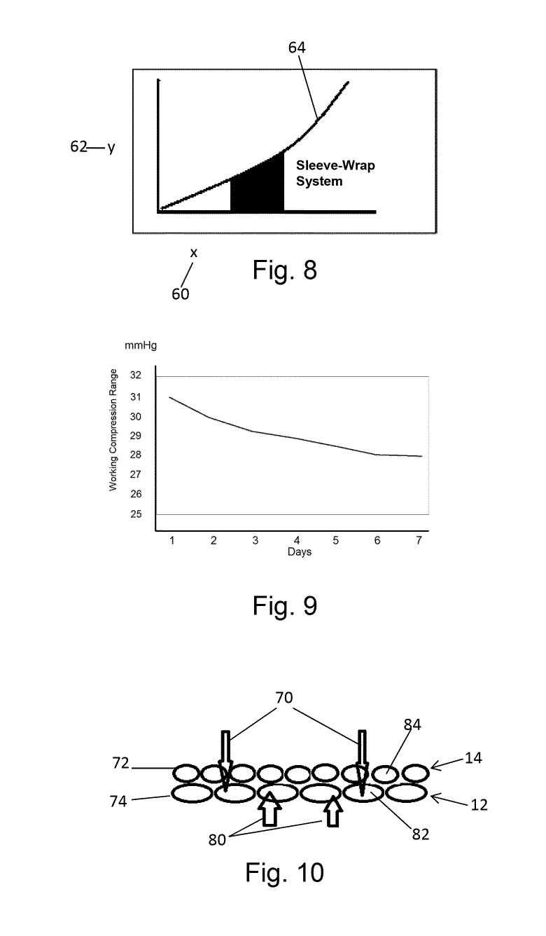

FIG. 8 illustrates the stress/strain relationship in the sleeve-wrap compression system 10. The sleeve-wrap compression system 10 exhibits less stiffness than a moderately stiff compression garment, such as a four-layer compression wrap, and has elasticity characteristics similar to that of a compression stocking. In the more elastic sleeve-wrap compression system 10, a larger change in stretch/stress 60 (due to a larger change in limb circumference) results in the defined change in actual compressive pressure 62. For example, in the relatively elastic sleeve-wrap compression system 10, an increase in compressive pressure/strain 60 of 10 mm Hg may be produced by a 5 cm increase in limb circumference. That is, in the relatively elastic sleeve-wrap compression system 10, the same amount of increase in compressive pressure 62 as in a stiff or moderately stiff compression garment is produced by an even larger increase in limb circumference (an even larger amount of stretch/strain 60). In other words, the relatively elastic sleeve-wrap compression system 10 exhibits a lower slope value, or stress/strain curve 64, than stiff or moderately stiff compression garments. Such a lower, more gradual stress/strain curve 64 is similar to that exhibited by a compression hosiery garment. As a result, the sleeve-wrap compression system 10 provides a more gradual change in applied compressive pressure 62 in response to a change in limb volume than stiff or moderately stiff compression garments, and particularly multi-layer compression wrap systems. Accordingly, the ability to provide a gradual change in applied compressive pressure 62 in response to a change in limb volume allows the sleeve-wrap compression system 10 to provide compressive pressure 62 within a defined, desired therapeutic range over time and with varying degrees of patient activity and rest. Maintaining compressive pressure 62 consistently within a desired therapeutic range during an extended course of treating venous ulcers can enhance healing outcomes.

In particular, recent research has shown that stiffness of a compression device affects venous ulcer healing rates. Stiff inelastic compression bandages and garments (which have a high stress/strain curve) rapidly lose therapeutic compression profiles as the volume of the limb decreases. Short-stretch bandages also have the disadvantageous tendency to lose a significant amount of pressure within the first few hours of application. For example, my testing showed that in one cohesive wrap applied on top of a second cohesive wrap about a cylinder, an initial 60 mm Hg compressive pressure dropped to about 20 mm Hg pressure after three hours. Stiff inelastic compression bandages can comprise tight, short-stretch bandages, such as one commercially available cohesive bandage under the name COBAN™ from 3M™ (3M Corporate Headquarters, 3M Center, St. Paul, Minn. 55144-1000), or semi-rigid zinc plaster bandages, such as one commercially available under the name Unna Boot from Medline Industries, Inc. (One Medline Place, Mundelein, Ill. 60060).

Elastic, or long-stretch, compression bandages and garments utilize the recoil force of elastic fibers to provide compression. As a result, elastic compression bandages and garments have advantages over inelastic bandages and garments by providing more consistent compression during changes in limb volume and during varying degrees of patient activity and by maintaining a constant interface pressure over a longer wear period.

Four-layer compression bandages combine aspects of both inelastic and elastic compression into one system. Such multi-layer systems include an absorbent pad layer, a crepe layer to hold the padding in place, a long-stretch bandage layer for providing compression, and a cohesive outer wrap. However, the stiffness of the cohesive outer wrap causes the predominant effect in such four-layer compression bandages to be similar to short-stretch bandages insofar as they do not provide significant compression during changes in limb volume. Over a 5-7 day wear cycle, four-layer compression bandages exhibit increasing slippage and substantial pressure loss (that is, less slippage and pressure loss than a purely inelastic bandage, but more than a purely elastic device). In addition, the wrapping procedure for a four-layer bandage is complex. An example of a such a four-layer compression bandage is one commercially available under the name PFOFORE® from Smith & Nephew Medical Ltd. (Hull HU3 2BN, England).

Moreover, with respect to healing of venous leg ulcers, O'Meara et al. have reported that multi-component systems (bandages or stockings) are more effective than single-component systems; that multi-component systems containing elastic, such as long-stretch elastic, are more effective than those composed mainly of inelastic, or short-stretch, constituents; and that two-component bandage systems perform as well as four-layer bandages.

Embodiments of the sleeve-wrap compression system 10 of the present invention comprise a multi-component system, preferably a two-layer system, comprising long-stretch elastic. As described, the sleeve-wrap compression system 10 exhibits a lower stress/strain curve 64 than stiff or moderately stiff conventional compression garments. Accordingly, the sleeve-wrap compression system 10 provides numerous advantages. For example, the sleeve-wrap compression system 10 provides the advantage of (1) easy application, in contrast to complex four-layer application procedures; (2) being maintained in a proper position on a patient's limb 20 with minimal slippage; (3) consistent compressive pressure 62 during an extended wear period, for example, over 5-7 days; (4) a controlled, gradual change in applied compressive pressure 62 in response to a change in limb volume; and (5) consistent compressive pressure 62 during varying degrees of patient activity and rest. Each of these aspects of the sleeve-wrap compression system 10 allows the system to control applied compressive pressure 62 so as to maintain a consistent working compression profile. As a result, the sleeve-wrap compression system 10 can maintain an optimal, therapeutic level of compressive pressure 62 for the treatment of leg ulcers over time.

As described herein, design aspects of the sleeve component 12 of the sleeve-wrap compression system 10 and the interaction between the sleeve 12 and wrap 14, individually and together, help keep the two-layer system 10 in a desired position on a limb 20 so that a stable working compressive pressure can be maintained over time. Similarly, features of the wrap 14, including defined stretch/compressive pressure correlations, a stretch/compression color indication system 50, and stretch characteristics of the wrap 14, provide for maintenance of a consistent working compression profile. FIG. 9 illustrates that the sleeve-wrap system 10 maintains working compression within a desired range for seven days while the system 10 is being worn. As shown in FIG. 9, one exemplary embodiment of the sleeve-wrap compression system 10 that provides an initial working compression of about 31 mm Hg is able to maintain compressive pressure above about 28 mm Hg over a seven day period, which is within 90% of the initial working compression.

Embodiments of the sleeve-wrap compression system and/or method 10 of the present invention can comprise multiple compressive pressure layers. In preferred embodiments, the sleeve-wrap compression system 10 comprises a two-layer system in which a single compressive wrap layer 14 described herein is utilized in combination with the compressive sleeve layer 12. One advantage of such a two-layer compression system is that the sleeve 12 and the wrap 14 comprise features that combine to form a single compressive entity. When applied to a patient's limb 20, the inner sleeve 12 exerts a first compressive pressure that secures the inner sleeve 12 in a therapeutic position on the limb 20, and when applied by stretching over the inner sleeve 12, the outer wrap 14 exerts a second compressive pressure and frictionally engages the inner sleeve 12, thereby securing the compression system 10 as a single compressive entity in the therapeutic position on the limb. That two-layer, single-entity compression system 10 minimizes, if not eliminates, any potential of slippage and/or wrinkling between the two layers, 12, 14, respectively, thereby facilitating comfort for the patient and smooth dispersion of compression throughout the system 10. The two-layer, single-entity compression system 10 further provides consistent compressive pressure during an extended wear period and varying degrees of patient activity and rest, and a controlled, gradual change in applied compressive pressure in response to a change in limb volume. In these ways, the compression system 10 of the present invention can provide enhanced effectiveness in the treatment of venous leg ulcers and/or edematous conditions of body extremities.

In another embodiment of the present invention, another compressive wrap layer 14 can be applied on top of the first compressive wrap layer 14 to create a three-layer compression system. An embodiment having such a third layer continues to provide the benefits of the two-layer, single-entity compression system 10 over which the third layer is applied.

In yet other alternative embodiments, a different wrap can be utilized for the second and/or third layers. For example, in an alternative two-layer compression system 10, a cohesive wrap can be applied to the sleeve layer 12 in order to provide a more rigid pressure useful in certain therapeutic scenarios. Likewise, in an alternative three-layer compression system, a cohesive wrap can be applied as the third layer on top of the two-layer sleeve-wrap compression system 10. Other combinations of components of conventional compression systems with either the sleeve 12 and/or the wrap 14 of the present invention are also envisaged.

The sleeve-wrap compression system 10 may optionally include a wound dressing for covering and thus protecting an open wound, such as an ulcer, under the applied compression system.

The sleeve-wrap compression system 10 can comprise anti-microbial properties 70, as shown in FIG. 10. In some embodiments, the sleeve 12 comprises copper technology 74 on the interior of the sleeve 12. Anti-microbial copper technology 74 that can be integrated into fabric is commercially available from Cupron, Inc. (Richmond, Va.). Such copper technology 74 provides a broad spectrum of anti-bacterial, anti-viral, and anti-fungal activity, and can eliminate 99.9% of bacteria and fungi that cause odors. Thus, such anti-microbial copper technology 74 in the sleeve 12 effectively reduces odor from wound drainage, promotes wound healing, and protects skin around the wound.

In some embodiments, the wrap 14 comprises silver 72 integrated into the wrap 14. Silver 72 provides a broad spectrum of anti-bacterial, anti-viral, and anti-fungal activity 70. Accordingly, silver 72 in the wrap 14 can reduce odor from wound drainage wicked to the wrap layer 14 and help prevent infectious contamination of the exterior of the wrap 14.

FIG. 10 illustrates anti-microbial action 70 in the fibers of the wrap 14 and on the interior of the sleeve 12. As shown in FIG. 10, copper 74 comprised in the inner sleeve layer 12 and silver 72 comprised in the outer wrap layer 14 act together as a double barrier to reduce odor, prevent cross contamination from a wound, and promote wound healing. These anti-microbial properties 70 give the sleeve-wrap compression system 10 an advantage over conventional compression systems that may suppress odor but do not actively kill microbes in exudate from a wound.

In some preferred embodiments of the sleeve-wrap compression system 10, both the sleeve 12 and the wrap 14 comprise hydrophilic yarns 82, 84 that can wick 80 moisture/fluid from a wound and surrounding skin to the surface of the outer wrap 14. For example, the inner skin facing surface of the sleeve 12 can comprise knitted terry loops 30, which are hydrophilic 82 so as to absorb moisture/fluid from the underlying wound and skin surfaces and wick 80 it vertically outward away from those underlying surfaces. Once fluid/moisture is wicked 80 away from the surfaces of a patient's wound and/or skin by the hydrophilic yarns 82 in the sleeve 12, the fluid/moisture is wicked 80 through the sleeve layer 12 to the wrap layer 14, where hydrophilic yarns 84 continue to wick 80 the fluid/moisture to the surface of the wrap 14. FIG. 10 illustrate the presence of hydrophilic wicking fibers 82 in the sleeve 12 and vertical wicking 80 of moisture/exudate from a wound through the sleeve layer 12 and through the wrap layer 14 to the surface of the outer wrap layer 14. At the surface of the wrap 14, the fluid/moisture can evaporate into the air. Thus, vertical wicking 80 through two layers 12, 14 in the sleeve-wrap compression system 10 provides a system and method for managing draining wounds that need compressive pressure therapy. Wicking 80 moisture/exudate from a wound helps keep the wound drier, prevents wound maceration, and enhances skin comfort.

In some embodiments of the sleeve-wrap compression system 10, a secondary absorptive dressing, such as an ABD pad, can be placed on the outside of the wrap layer 14 to help absorb moisture/drainage wicked 80 away from a wound. Once soiled with drainage wicked 80 vertically outwardly from the wound by the sleeve 12 and wrap layers 14, the secondary dressing can be changed without having to change the sleeve-wrap compression system 10 or a primary dressing adjacent the wound.

Although the present invention has been described with reference to particular embodiments, it should be recognized that these embodiments are merely illustrative of the principles of the present invention. Those of ordinary skill in the art will appreciate that a sleeve-wrap compression system and/or methods 10 of the present invention may be constructed and implemented in other ways and embodiments. Accordingly, the description herein should not be read as limiting the present invention, as other embodiments also fall within the scope of the present invention.

What is claimed is:

1. A compression system, comprising:
a seamless, inner sleeve comprising a long-stretch elastomeric material and an interior terry surface; and
an elongated outer wrap comprising a long-stretch elastomeric material;
wherein, when applied to a patient's limb, the inner sleeve exerts a first compressive pressure that secures the inner sleeve in a therapeutic position on the limb, and
wherein, when applied by stretching over the inner sleeve, the outer wrap exerts a second compressive pressure and frictionally engages the inner sleeve, thereby securing the compression system as a single compressive entity in the therapeutic position on the limb.

2. The system of claim 1, wherein the first compressive pressure exerted by the inner sleeve comprises about 5-10 mm Hg of compressive pressure uniformly throughout the sleeve.

3. The system of claim 1 wherein the inner sleeve further comprises a stitch construction that permits horizontal stretch with minimal vertical stretch.

4. The system of claim 1,
wherein the inner sleeve further comprises a reciprocated heel pouch and an open toe, each adapted to guide application of the inner sleeve and to maintain the inner sleeve in the therapeutic position on the limb, and
wherein wrinkling or bunching of the inner sleeve is reduced so that the inner sleeve compacts evenly onto the limb under the second compressive pressure exerted by the outer wrap.

5. The system of claim 4, wherein the inner sleeve is configured to disperse the compressive pressure exerted by the outer wrap smoothly about the therapeutic position on the limb.

6. The system of claim 1 wherein the second compressive pressure exerted by the outer wrap comprises defined amounts of compressive pressure correlated with various amounts of stretch.

7. The system of claim 1, wherein the outer wrap further comprises a range of stretch to about 165% greater than a relaxed length.

8. The system of claim 1, wherein the second compressive pressure exerted by the outer wrap from a first stretch to an about 30% greater length than a relaxed length to a second stretch to an about 100% greater length than the relaxed length ranges from about 20 mm Hg to about 30 mm Hg of compressive pressure.

9. The system of claim 1, wherein the outer wrap is configured to provide about 5-10 mm Hg compressive pressure when stretched to a first, about 30% greater length than a relaxed length, about 20 mm Hg compressive pressure when stretched to a second, about 75% greater length than the relaxed length, and about 30-35 mm Hg compressive pressure when stretched to a third, about 100% greater length than the relaxed length.

10. The system of claim 1, wherein the outer wrap further comprises a stitch construction that permits longitudinal stretch with minimal cross-stretch.

11. The system of claim 1,
wherein the long-stretch elastomeric material in the outer wrap comprises spandex having a denier of about 380-440, and
wherein the outer wrap further comprises about 12-18 ends of spandex per inch.

12. The system of claim 1,
wherein the first compressive pressure exerted by the inner sleeve and the second compressive pressure exerted by the outer wrap cumulatively comprise a working compression profile, and
wherein the compression system further comprises an elastic stress/strain curve such that the single compressive entity provides a gradual change in the working compression profile in response to a change in limb volume.

13. The system of claim 1,
wherein the first compressive pressure exerted by the inner sleeve and the second compressive pressure exerted by the outer wrap cumulatively comprise a working compression profile, and
wherein the single compressive entity maintains an initial working compression profile on the limb within a defined therapeutic range during changes in limb volume.

14. The system of claim 1,
wherein the first compressive pressure exerted by the inner sleeve and the second compressive pressure exerted by the outer wrap cumulatively comprise a working compression profile, and
wherein the single compressive entity maintains an initial working compression profile on the limb with a variance of less than about 20% over a seven day period.

15. The system of claim 1, further comprising a color/compression change indication system, wherein a particular amount of stretch of the outer wrap creates a unique shade of color representative of a particular amount of compressive pressure, whereby a user can readily determine a proper amount of stretch for providing a desired amount of compressive pressure.

16. The system of claim 1, wherein each of the inner sleeve and the outer wrap further comprise broad spectrum anti-microbial properties.

17. The system of claim 1, wherein each of the inner sleeve and the outer wrap further comprise a hydrophilic yarn adapted to wick moisture/fluid from a wound and surrounding skin to an outer surface of the outer wrap.

18. The system of claim 17, wherein the inner sleeve hydrophilic yarn further comprises a knitted terry yarn.

19. The system of claim 1, further comprising a plurality of the outer wraps, wherein another one of the outer wraps is applied on top of the outer wrap.

20. The system of claim 1, wherein the outer wrap comprises a cohesive wrap.

21. A compression system, comprising:
a seamless sleeve comprising (a) a long-stretch elastomeric material, (b) a stitch construction that permits horizontal stretch with minimal vertical stretch, and (c) an interior terry surface,
wherein, when applied to a patient's limb, the sleeve exerts about 5-10 mm Hg of compressive pressure uniformly throughout the sleeve that secures the sleeve in a therapeutic position on the limb, and
wherein the sleeve is configured to have secured thereto a compression wrap overlying the sleeve.

22. The system of claim 21,
wherein the sleeve further comprises a reciprocated heel pouch and an open toe, each adapted to guide application of the sleeve and to maintain the sleeve in the therapeutic position on the limb, and
wherein wrinkling or bunching of the sleeve is reduced so that the sleeve compacts evenly onto the limb under compressive pressure exerted by the overlying compression wrap.

23. The system of claim 22, wherein the sleeve is configured to disperse the compressive pressure exerted by the overlying compression wrap smoothly about the therapeutic position on the limb.

24. A compression system, comprising:
an elongated wrap comprising (a) a long-stretch elastomeric material, (b) a stitch construction having minimal cross-stretch, and (c) a range of longitudinal stretch to about 165% greater than a relaxed length;
wherein, when applied to a patient's limb, the wrap exerts a compressive pressure that secures the wrap in a therapeutic position on the limb, and
wherein the compressive pressure exerted by the wrap comprises defined amounts of compressive pressure correlated with various amounts of longitudinal stretch.

25. The system of claim 24,
wherein the compressive pressure exerted by the wrap from a first stretch to an about 30% greater length than the relaxed length to a second stretch to an about 100% greater length than the relaxed length ranges from about 20 mm Hg to about 30 mm Hg of compressive pressure.

26. The system of claim 24,
wherein the wrap is configured to provide about 5-10 mm Hg compressive pressure when stretched to a first, about 30% greater length than the relaxed length, about 20 mm Hg compressive pressure when stretched to a second, about 75% greater length than the relaxed length, and about 30-35 mm Hg compressive pressure when stretched to a third, about 100% greater length than the relaxed length.

27. The system of claim 24,
wherein the long-stretch elastomeric material comprises spandex having a denier of about 380-440, and
wherein the wrap further comprises about 12-18 ends of spandex per inch.
